(19) United States
(12) Patent Application Publication
(10) Pub. No.: US 2005/0003124 A1
(43) Pub. Date: Jan. 6, 2005

(54) Barrier coating

(75) Inventors: Nasser Beldi, Le Havre Cedex (FR); Eric Adriansens, Le Havre Cedex (FR)

Correspondence Address: SUGHRUE MION, PLLC, 2100 PENNSYLVANIA AVENUE, N.W., SUITE 800, WASHINGTON, DC, 20037, US

(73) Assignee: SIDEL

(21) Appl. No.: 10/901,957

(22) Filed: Jul. 30, 2004

Related U.S. Application Data
(62) Division of application No. 10/333,719, filed on Jan. 24, 2003.

(30) Foreign Application Priority Data
Aug. 1, 2000 (FR) 00/10100

(51) Int. Cl. B32B 27/06; B32B 17/06; B32B 1/08; B32B 27/36; C23C 4/04

(52) U.S. Cl. 428/35.7; 428/446; 428/408; 428/216; 428/426; 428/480; 427/452

(57) ABSTRACT

A barrier coating to gases deposited on a polymer substrate by low pressure plasma, wherein it includes a silicon oxide barrier which is coated with a protective hydrogenated amorphous carbon film.

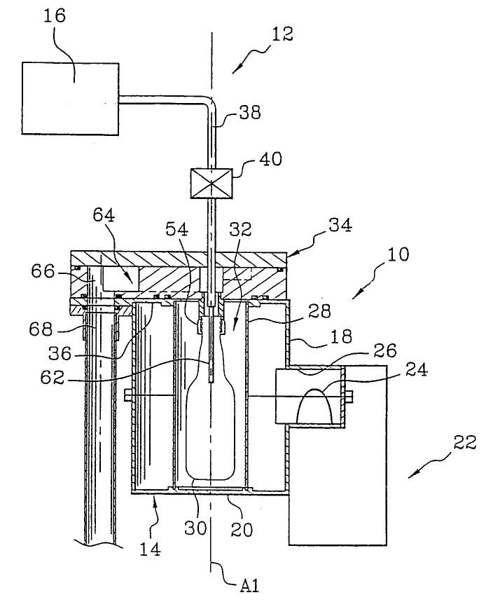

The invention concerns thin film barrier coatings deposited by means of low-pressure plasma. In order to obtain such coatings, a reactive fluid is injected under low pressure into a treatment area. This fluid, when it is brought up to the pressures used, is generally gaseous. In the treatment area, an electromagnetic field is established to change this fluid over to the plasma state, that is, to cause at least a partial ionization thereof. The particles issuing from this ionization mechanism can then be deposited on the walls of the object that is placed in the treatment area.

Deposits by low pressure plasmas, also called cold plasmas, allow thin films to be deposited on temperature-sensitive objects made of plastic while ensuring a good physical-chemical adhesion of the coating deposited on the object.

Such deposition technology is used in various applications. One of these applications concerns the deposition of functional coatings on films or containers, particularly for the purpose of reducing their permeability to gases such as oxygen and carbon dioxide.

In particular, it has recently been determined that such a technology can be used to coat plastic bottles with a barrier material, which bottles are used to package products that are sensitive to oxygen, such as beer and fruit juices, or carbonated products such as sodas.

Document WO99/49991 describes a device that allows the internal or external face of a plastic bottle to be covered with a barrier coating. In this document, the use of a coating with a hydrogenated amorphous carbon base is considered.

Furthermore, the use is known of dense coatings with an SiOx type silicon oxide base deposited by low-pressure plasma to reduce the permeability of plastic substrates. However, when they are deposited on deformable substrates, these coatings are unable to resist the deformations that the substrate undergoes. Indeed, in spite of the very strong adhesion to the substrate, the deformation thereof leads to the appearance of micro-cracks in the coating, which impairs the barrier properties.

Some applications require that the coating be able to resist the deformations of the substrate. Thus, a plastic bottle full of a carbonated liquid such as soda or beer is subject to an internal pressure of several bars which, in the case of the lightest bottles, can lead to creep in the plastic material resulting in a slight increase in the bottle's volume. In this case, dense materials like SiOx, because they have an elasticity that is much lower than that of the plastic substrate, can deteriorate to the point of losing a large part of the bottle's barrier properties.

The purpose of the invention, therefore, is to propose a new type of coating optimized to obtain a very high level of barrier properties.

To that end, the invention first proposes a gas barrier coating deposited on a polymer substrate by low-pressure plasma, characterized in that it has a barrier layer with a silicon oxide base that is covered with a protective layer of hydrogenated amorphous carbon.

According to other characteristics of this coating, according to the invention:
the barrier layer is composed essentially of silicon oxide with the formula SiOx, where x is between 1.5 and 2.3;
the barrier layer has a thickness of between 8 and 20 nanometers and the protective layer has a thickness of less than 20 nanometers;
the protective layer has a thickness of less than 10 nanometers;
the barrier layer is obtained by low-pressure plasma deposition of an organosilicon compound in the presence of an excess of oxygen;
the protective layer is obtained by low-pressure plasma deposition of a hydrocarbonated compound;
between the substrate and the barrier layer, an interface layer is deposited;
the interface layer is obtained by low pressure plasma deposition of an organosilicon compound in the absence of additional oxygen; and
the interface layer is obtained by low-pressure plasma deposition of an organosilicon compound in the presence of nitrogen.

The invention also concerns a method of implementing a low pressure plasma to deposit a barrier coating on a substrate to be treated, of the type in which the plasma is obtained by partial ionization, under the action of an electromagnetic field, of a reactive fluid injected under low pressure into the treatment area, characterized in that it has at least a step consisting of depositing a barrier layer with a silicon oxide base, and in that it has a subsequent step consisting of depositing on the barrier layer a protective layer of hydrogenated amorphous carbon obtained by low pressure plasma.

According to other characteristics of the method according to the invention:
the protective layer is obtained by low-pressure plasma deposition of a hydrocarbonated compound;
the hydrocarbonated compound is acetylene;
the barrier layer is obtained by low-pressure plasma deposition of an organosilicon compound in the presence of an excess of oxygen;
the method includes a prior step consisting of depositing an interface layer between the substrate and the barrier layer; and
the interface layer is obtained by converting to plasma a mixture comprised of at least an organosilicon compound and a nitrogen compound.

The invention also concerns a container made of polymer material, characterized in that at least one of its faces is covered with a barrier coating of the type described above. this container is covered with the barrier coating, for example, on its inner face, and the container can be a polyethylene terephtalate bottle.

Other characteristics and advantages of the invention will appear from the following detailed description, with reference to the single attached FIGURE.

Illustrated in the single FIGURE is a diagrammatic view in axial cross section of one form of embodiment of a processing station 10 enabling the implementation of a method according to the features of the invention. The invention will be described here within the scope of the treatment of containers made of plastic material. More specifically, a method and a device will be described that allow a barrier coating to be deposited on the inner face of a plastic bottle.

The station 10 can, for example, make up part of a rotary machine including a carrousel driven in continuous rotational movement around a vertical axis.

The treatment station 10 includes an external enclosure 14 that is made of an electrically conductive material such as metal, and which is formed from a tubular cylindrical wall 18 with a vertical axis Al. The enclosure 14 is closed at its lower end by a bottom wall 20.

Outside the enclosure 14, attached thereto, there is a housing 22 that includes the means (not shown) for creating inside the enclosure 14 an electromagnetic field capable of generating a plasma. In this instance, it can involve means suitable for generating an electromagnetic radiation in the UHF range, that is, in the microwave range. In this case, the housing 22 can therefore enclose a magnetron the antenna 24 of which enters into a wave-guide 26. For example, this wave-guide 26 is a tunnel of rectangular cross section that extends along a radius of the axis Al and opens directly into the enclosure 14 through the sidewall 18. However, the invention could also be implemented within the scope of a device furnished with a source of radio-frequency type radiation, and/or the source could also be arranged differently, for example at the lower axial end of the enclosure 14.

Inside the enclosure 14 there is a tube 28 with axis Al which is made of a material that is transparent to the electromagnetic waves introduced into the enclosure 14 via the wave-guide 26. For example, the tube 28 can be made of quartz. This tube 28 is intended to receive a container 30 to be treated. Its inside diameter must therefore be adapted to the diameter of the container. It must also delimit a cavity 32 in which a partial vacuum will be created after the container is inside the enclosure.

As can be seen in the figure, the enclosure 14 is partially closed at its upper end by an upper wall 36 that has a central opening with a diameter appreciably equal to the diameter of the tube 28, so that the tube 28 is completely open upward to allow the container 30 to be placed in the cavity 32. On the contrary, it can be seen that the lower metal wall 20, to which the lower end of the tube 28 is sealably attached, forms the bottom of the cavity 32.

To close the enclosure 14 and the cavity 32, the treatment station 10 has a cover 34 that is axially movable between an upper position (not shown) and a lower closed position illustrated in the figure. In the upper position, the cover is sufficiently open to allow the container 30 to be introduced into the cavity 32.

In the closed position, the cover 34 rests sealably against the upper face of the upper wall 36 of the enclosure 14.

In a particularly advantageous way, the cover 34 does not function solely to sealably close the cavity 32. Indeed, it has additional parts.

Firstly, the cover 34 has means to support the container. In the illustrated example, the containers to be treated are bottles made of thermoplastic material, such as polyethylene terephtalate (PET). These bottles have a small collar that extends radially out from the base of their neck in such a way that they can be grasped by a gripper cup 54 that engages or snaps around the neck, preferably under said collar. Once it is picked up by the gripper cup 54, the bottle 30 is pressed upward against the support surface of the gripper cup 54. Preferably, this support surface is impermeable so that when the cover is in the closed position, the interior space of the cavity 32 is separated by the wall of the container into two parts: the interior and the exterior of the container.

This arrangement allows only one of the two surfaces (inner or outer) of the wall of the container to be treated. In the example illustrated, only the inner surface of the container's wall is intended to be treated.

This internal treatment requires that both the pressure and the composition of the gases present inside the container be controllable. To accomplish this, the interior of the container must be connected with a vacuum source and with a reactive fluid feed device 12. Said feed device includes a source of reactive fluid 16 connected by a tube 38 to an injector 62 that is arranged along axis Al and which is movable with reference to the cover 34 between a retracted position (not shown) and a lowered position in which the injector 62 is inserted into the container 30 through the cover 34. A control valve 40 is interposed in the tube 38 between the fluid source 16 and the injector 62. The injector 62 can be a tube with porous wall which makes it possible to optimize the distribution of the injection of reactive fluid into the treatment area.

In order for the gas injected by the injector 62 to be ionized and to form a plasma under the effect of the electromagnetic field created in the enclosure, the pressure in the container must be lower than the atmospheric pressure, for example on the order of 10⁻⁴ bar. To connect the interior of the container with a vacuum source (such as a pump), the cover 34 includes an internal channel 64 a main termination of which opens into the inner face of the cover, more specifically at the center of the support surface against which the neck of the bottle 30 is pressed.

It will be noted that in the proposed mode of embodiment, the support surface is not formed directly on the lower face of the cover, but rather on a lower annular surface of the gripper cup 54 which is attached beneath the cover 34. Thus, when the upper end of the neck of the container is pressed against the support surface, the opening of the container 30, which is delimited by this upper end, completely encloses the orifice through which the main termination opens into the lower face of the cover 34.

In the illustrated example, the internal channel 64 of the cover 24 includes an interface end 66 and the vacuum system of the machine includes a fixed end 68 that is arranged so that both ends 66, 68 face each other when the cover is in the closed position.

The illustrated machine is designed to treat the inner surface of containers that are made of a relatively deformable material. Such containers could not withstand an overpressure on the order of 1 bar between the outside and the inside of the bottle. Thus, in order to obtain a pressure inside the bottle of about 10⁻4 bar without deforming the bottle, the part of the cavity 32 outside the bottle must also be at least partially depressurized. Also, the internal channel 64 of the cover 34 includes, in addition to the main termination, an auxiliary termination (not shown) which also opens through the lower face of the cover, but radially outside the annular support surface against which the neck of the container is pressed.

Thus, the same pumping means simultaneously create the vacuum inside and outside the container.

In order to limit the volume of pumping, and to prevent the appearance of a unusable plasma outside the bottle, it is preferable that the pressure outside not fall below 0.05 to 0.1 bar, compared to a pressure of about 10⁻⁴ bar inside. It will also be noted that the bottles, even those with thin walls, can withstand this difference in pressure without undergoing significant deformation. For this reason, the design includes providing the cover with a control valve (not shown) that can close off the auxiliary termination.

The operation of the device just described can be as follows.

When the container has been loaded on the gripper cup 54, the cover is lowered into its closed position, and at the same time the injector is lowered through the main termination of the channel 64, but without blocking it.

When the cover is in the closed position, the air contained in the cavity 32, which cavity is connected to the vacuum system by the internal channel 64 of the cover 34, can be exhausted.

At first, the valve is opened so that the pressure drops in the cavity 32, both inside and outside the container. When the vacuum level outside the container has reached a sufficient level, the system closes the valve. The pumping can then continue exclusively inside the container 30.

When the treatment pressure is reached, the treatment can begin according to the method of the invention.

In a preferred variation of the invention, the deposition method comprises a first step consisting of depositing directly on the substrate, in this instance on the inner surface of the bottle, an interface layer composed essentially of silicon, carbon, oxygen, nitrogen, and hydrogen. Obviously the interface layer will also be able to include other elements in small quantities or trace amounts, these other components originating from impurities contained in the reactive fluids used, or simply from impurities due to the presence of residual air still present after completion of pumping.

To obtain such interface layer, a mixture comprising an organosilicon compound, that is, comprised essentially of carbon, silicon, oxygen and hydrogen, and a nitrogen compound are injected into the treatment area.

The organosilicon compound, for example, can be an organosiloxane, and the nitrogen compound can simply be nitrogen. The use of an organosilazane containing at least one atom of nitrogen could also be considered for the organosilicon compound.

Organosiloxanes such as hexamethyldisiloxane (HMDSO) or tetramethyl-disiloxane (TMDSO) are generally liquid at ambient temperature. Also, in order to inject them into the treatment area, a carrier gas can be used which is combined in a bubble tube with fumes from the organosiloxane, or simply work at the saturated vapor pressure of the organosiloxane.

If a carrier gas is used, it can be a rare gas such as helium or argon. Advantageously, however, nitrogen gas (N2) can simply be used as the carrier gas.

According to a preferred form of embodiment, this interface layer is obtained by injecting HMDSO into the treatment area, in this instance the internal volume of a 500 ml plastic bottle at a flow rate of 4 sccm (standard cubit centimeters per minute), using nitrogen gas as the carrier gas at a flow rate of 40 sccm. The microwave power used, for example, is 400 W, and the treatment time is on the order of 0.5 second. In this way, in a device of the type described above, an interface layer is obtained that has a thickness of only a few nanometers.

Various analyses have shown that the interface layer thus deposited contains silicon, of course, but it is particularly rich in carbon and nitrogen. It also contains oxygen and hydrogen. These analyses also show that there are numerous N-H type chemical bonds.

Tests have shown that, during this step of depositing the interface layer, it is possible to replace the nitrogen gas (N2) with air (still at a flow rate of 40 sccm in the proposed example) which is known to be composed of nearly 80% nitrogen.

On this interface layer, it is then possible to deposit a barrier layer of SiOx material. There are numerous techniques for depositing this type of material by low-pressure plasma. For example, 80 sccm of oxygen gas (O2) could simply be added to the HMDSO/N2 mixture. This addition can be done either instantaneously or progressively.

The oxygen, usually in excess in the plasma, causes the nearly complete elimination of the carbon, nitrogen, and hydrogen atoms that are contributed either by the HMDSO or by the nitrogen used as the carrier gas. An SiOx material is thus obtained, in which x, which expresses the ratio of the quantity of oxygen to the quantity of silicon, is generally between 1.5 and 2.2 under the process conditions used. Under the conditions given above, a value of x of more than 2 can be obtained. Of course, as in the first step, impurities due to the method can be incorporated in small quantities in this layer without significantly changing the properties.

The duration of the second processing step can vary, for example, from 2 to 4 seconds. The thickness of the barrier layer thus obtained is therefore on the order of 6 to 20 nanometers.

The two steps of the deposition process can be performed as two completely separate steps, or as two linked steps without the plasma being terminated between them.

According to the features of the invention, the barrier layer can be covered with a protective layer of hydrogenated amorphous carbon deposited by low-pressure plasma.

From document WO99/49991 it is known that hydrogenated amorphous carbon can be used as a barrier layer. However, in order to obtain good barrier values, it is necessary to deposit a thickness on the order of 80 to 200 nanometers, because thicknesses of more than this produce a not negligible yellowish coloration of the carbon layer.

Within the scope of the present invention, the deposited carbon layer has a thickness that is preferably less than 20 nanometers. At this level of thickness, the contribution of this additional layer in terms of barrier to gases is not an influencing factor, even if this contribution exists.

The principal benefit of adding a hydrogenated amorphous carbon layer of such reduced thickness is in the fact that it has been determined that the SiOx layer protected in this way has better resistance to the different deformations of the plastic substrate.

By way of example, this layer of hydrogenated amorphous carbon can be produced by introducing acetylene gas into the treatment area at a flow rate of about 60 sccm for about 0.2 second. The protective layer thus deposited is thin enough that its coloration is hardly discernible to the naked eye, while significantly increasing the overall strength of the coating.

The barrier coating thus obtained is particularly heavy duty. Thus, a standard 500 ml PET bottle on which a coating according to the specifications of the invention has been deposited has a permeability rate of less than 0.002 cubic centimeter of oxygen entering into the bottle per day, and it preserves barrier properties at an acceptable level even if it undergoes creep corresponding to an increase in volume of more than 5%.

1-9. (Canceled).

10. A container made of polymer material, characterized in that at least one of its faces is covered with a gas barrier coating layer, deposited on the polymer material by low-pressure plasma, said barrier coating layer including a silicon oxide base that is covered with a protective layer of hydrogenated amorphous carbon.

11. The container according to claim 10, characterized in that an inner face of the container is covered with the barrier coating layer.

12. The container according to claim 10, characterized in that the container is a bottle made of polyethylene terephtalate.

13. Method of implementing a low pressure plasma to deposit a barrier coating on a substrate to be treated, of the type in which the plasma is obtained by partial ionization, under the action of an electromagnetic field, of a reactive fluid injected under low pressure into the treatment area, comprising the following steps:
depositing a barrier layer with a silicon oxide base, and
depositing on the barrier layer a protective layer of hydrogenated amorphous carbon obtained by low-pressure plasma.

14. Method according to claim 13, characterized in that the protective layer is obtained by low-pressure plasma deposition of a hydrocarbonated compound.

15. Method according to claim 14, characterized in that the hydrocarbonated compound is acetylene.

16. Method according to claim 13, characterized in that the barrier layer is obtained by low-pressure plasma deposition of an organosilicon compound in the presence of an excess of oxygen.

17. Method according to claim 13, characterized in that it includes a prior step consisting of depositing an interface layer between the substrate and the barrier layer.

18. Method according to claim 17, characterized in that the interface layer is obtained by converting to plasma a mixture comprised of at least an organosilicon compound and a nitrogen compound.
